(19) United States
(12) Patent Application Publication
(10) Pub. No.: US 2007/0207382 A1
(43) Pub. Date: Sep. 6, 2007

(54) Positive plate for alkaline secondary batteries and alkaline secondary battery

(75) Inventors: Tetsuya Yamane, Takasaki-shi (JP); Takayuki Yano, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/527,709

(22) Filed: Sep. 27, 2006

(30) Foreign Application Priority Data
Sep. 29, 2005 (JP) 2005-284637

(51) Int. Cl. H01M 4/32; H01M 4/62

(52) U.S. Cl. 429/223; 429/212

(57) ABSTRACT

A positive plate for alkaline secondary batteries has a porous substrate having electrical conductivity and vacancies and a positive mixture filled into the vacancies of the porous substrate. The positive mixture includes a positive electrode active material and a binding agent, the positive electrode active material having generally spherical first particles containing higher-ordered nickel hydroxide, and nonspherical second particles containing nickel hydroxide and having an average valence number of nickel lower than an average valence number of nickel in the first particles.

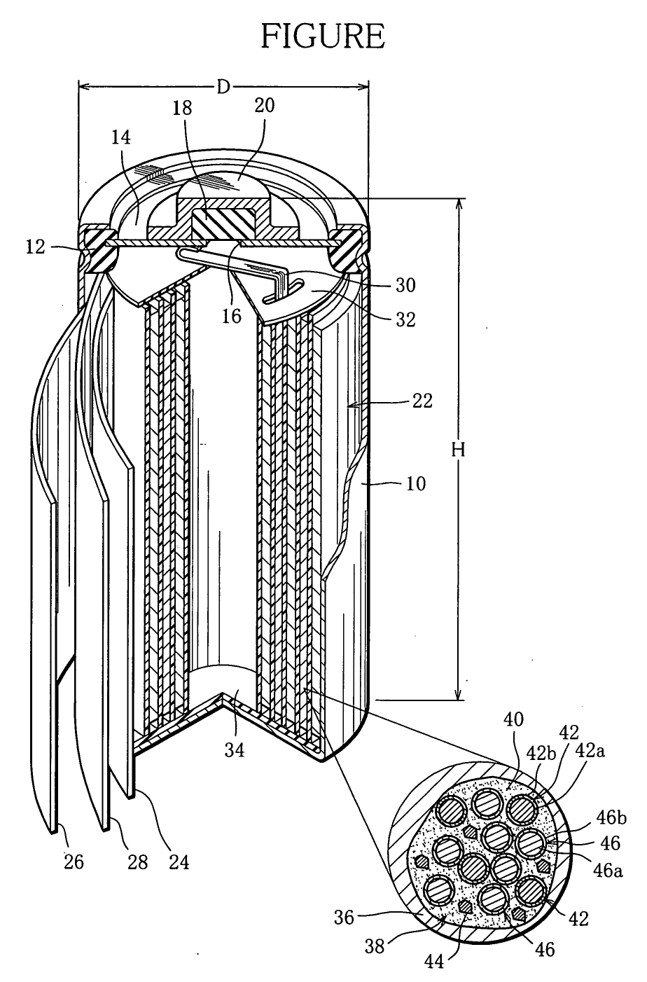

### BACKGROUND OF THE INVENTION

1. Field of the Invention

The present invention relates to a positive plate for alkaline secondary battery and an alkaline secondary battery.

2. Description of the Related Art

An alkaline secondary battery, which is in heavy usage as a portable energy source for various electrical or electronic equipment, is generally constructed as described below.

For example, a nickel-hydrogen secondary battery comprises an exterior can which has a cylindrical shape with a bottom. The bottom of the exterior can functions as a negative electrode terminal. An electrode assembly is housed within the exterior can.

The electrode assembly is fabricated such that a positive plate, a negative plate and a separator are spirally wound. The separator is disposed between the positive plate and the negative plate, having electrical insulating properties and liquid permeability. The positive plate comprises a porous substrate made of nickel, which is filled with a positive mixture including nickel-hydroxide particles as a positive electrode active material. The negative plate comprises an electrically conductive sheet, which retains a negative mixture including hydrogen-storing alloy particles as a negative active material. A part of the negative plate is positioned at the outermost periphery of the electrode assembly such that the part of the negative plate is contacted with the inner surface of the exterior can, whereby electrical conductivity between the negative plate and the exterior can be secured.

Furthermore, an alkaline electrolyte such as a KOH electrolyte is poured in a predetermined amount into the exterior can. The opening end of the exterior can is sealed with a cap which also serves as a positive terminal.

The positive plate as described above is of non-sintered type, i.e. pasted type, and has become the main current in view of high capacity of batteries. The pasted-type positive plate is generally made as given below.

First of all, an active material, a binding material and water are mixed at a predetermined ratio to prepare a slurry with a predetermined viscosity for a positive electrode. As the active material, nickel-hydroxide particles, or eutectic-crystal particles of nickel-hydroxide particles and Co, Zn or the like can be used. After the vacancies of the porous substrate have been filled with this positive-electrode slurry, the porous substrate is subjected to drying and rolling treatments, and finally finished into a shape with a predetermined size.

Recently, a higher-capacity battery has been strongly demanded. In order to respond to the demand, Japanese Patent Nos. 2765008, 3490825, 3617203, and 3429741 disclose the use of higher-ordered nickel hydroxide as a positive active material. The use of higher-ordered nickel hydroxide decreases the volume of a part of the negative-plate for discharging reserve, while increases the volume of a positive plate defining the battery capacity, by this decreased volume.

It should be noted that higher-ordered nickel hydroxide is the one obtained by subjecting nickel hydroxide to oxidizing treatment so as to convert a part of nickel hydroxide or its whole into nickel oxyhydroxide. The average valence number of nickel in higher-ordered nickel hydroxide is higher ordered than that of nickel in nickel hydroxide.

When higher-ordered nickel hydroxide is used as a positive active material, selection of a binding material is carried out such that the stability of a positive-electrode slurry, and the excellent filling properties of the positive-electrode slurry into a porous substrate can be secured.

For example, as the binding material, a straight-chain binding material such as carboxymethyl cellulose (CMC), hydroxypropyl methylcellulose (HPMC), and methyl cellulose (MC), a hydrophilic resin such as sodium polyacrylate (SPA), various surface-active agents, or polytetrafluoroethylene (PTFE), or the like is used.

However, in the case of a positive-electrode slurry including higher-ordered nickel hydroxide particles, the active surfaces of the higher-ordered nickel hydroxide particles adsorb the binding material, whereby the fluidity of the slurry is decreased while the slurry becomes poor in stability. As a result, problems that the filling of a porous substrate with a positive slurry becomes non-uniform, and that the filling density of a positive mixture is decreased occur.

When cobalt hydroxide is added to the positive slurry, the viscosity of the positive slurry is stabilized while the filling density of the positive mixture is increased. However, when higher-ordered nickel hydroxide is used as the active material, cobalt hydroxide is in a state wherein it is stable and higher-ordered, prior to the activating treatment of the fabricated battery. As a result, the problem that the capacity of the obtained battery is decreased by a portion due to the added cobalt hydroxide occurs.

Furthermore, Japanese Patent No. 3469766 discloses that two types of particles are mixed for use as a positive active material. One type of the particles comprises a core material of higher-ordered nickel hydroxide, the surface of which is coated with a higher-ordered cobalt compound. The other type of the particles comprises a core material of non-higher-ordered nickel hydroxide, the surface of which is coated with a higher-ordered cobalt compound.

In this case, the surface area of higher-ordered nickel hydroxide can be controlled by adjusting the mixing ratio of the two types of particles. Therefore, the adsorption reaction of the binding material to higher-ordered nickel hydroxide can be weakened so as to enhance stability of the positive-electrode slurry.

However, with passage of time, variation arises in the concentration of the binding material which exists near the surface of each particle of the positive active material. As a result, after a long-term storage, the positive-electrode slurry is destabilized whereby it is difficult to attain a high density filling with the positive mixture.

Besides, Japanese Unexamined Patent publication No. 2003-109588 discloses that a surface active agent is further added to a positive-electrode slurry including higher-ordered cobalt hydroxide.

However, when a surface active agent is added to a positive-electrode slurry which includes higher-ordered nickel hydroxide, the viscosity of the positive-electrode slurry is remarkably decreased, and then the positive-electrode slurry is destabilized. Thus, the positive-electrode slurry irregularly flows during the filling of the positive-electrode slurry in the porous substrate and drying of the positive-electrode slurry. As a result, variation in the filling density of the positive-electrode slurry occurs on the porous substrate, whereby it is difficult to fill the porous substrate with a positive mixture such that the positive mixture can be homogeneous and in a high density.

As can be seen also from the prior art as described above, a positive plate manufactured by using a positive-electrode slurry including higher-ordered nickel hydroxide as an active material can not be filled with a positive mixture in a high density. Accordingly, high capacity can not be attained to such a degree that the demand can be satisfied in a battery in which the positive plate is incorporated.

### SUMMARY OF THE INVENTION

It is an object of the invention to provide a positive plate for an alkaline secondary battery, the positive plate being filled with a positive mixture in a high density.

Furthermore, it is another object of the invention to provide an alkaline secondary battery having a positive plate for alkaline secondary batteries, the positive plate being filled with a positive mixture in a high density, the alkaline secondary battery having a high capacity and being excellent in cycle life characteristics.

In order to achieve the object mentioned above, a positive plate for alkaline secondary batteries according to the present invention comprises a porous substrate having an electrical conductivity and vacancies; and a positive mixture filled into the vacancies of the porous substrate, the positive mixture including a positive electrode active material and a binding agent, the positive electrode active material having generally spherical first particles containing higher-ordered nickel hydroxide, and nonspherical second particles containing nickel hydroxide and having an average valence number of nickel lower than an average valence number of nickel in the first particles.

In order to achieve another object mentioned above, an alkaline secondary battery according to the present invention comprises a container; an alkaline electrolyte housed in the container; and an electrode assembly housed in the container, the electrode assembly including a positive plate, a negative plate, and a separator, the positive plate and the negative plate overlapping each other with the separator sandwiched therebetween, the positive plate including a porous substrate having an electrical conductivity and vacancies, and a positive mixture filled into the vacancies of the porous substrate, the positive mixture containing an active material and a binding agent, the active material having generally spherical first particles containing higher-ordered nickel hydroxide, and nonspherical second particles containing nickel hydroxide and having an average valence number of nickel lower than an average valence number of Ni in the first particles.

### BRIEF DESCRIPTION OF THE DRAWING

The present invention will become more fully understood from the detailed description given hereinbelow and the accompanying drawing which is given by way of illustration only, and thus, is not limitative of the present invention, and wherein:

The FIGURE is a partially cutaway view showing a nickel-hydrogen secondary battery according to one embodiment of the present invention, wherein the inside of the circle in the FIGURE schematically shows a partially enlarged sectional view of a positive plate.

### DETAILED DESCRIPTION

A cylindrical nickel-hydrogen secondary battery of the AA-size of one embodiment of the present invention will be described below in detail with reference to the attached drawing.

As shown in the FIGURE, the battery comprises a cylindrical container 10 opening at one end and closed at the other. The container 10 has an outer diameter D of 13.5 mm to 14.5 mm, both inclusive. The container 10 has electrical conductivity and functions as a negative electrode terminal. A cover plate 14 having electrical conductivity is disposed in the opening of the container 10 with a ring-shape insulating-packing 12. The insulating-packing 12 and the cover plate 14 are fixed within the opening by subjecting the edge of the opening to a caulking process.

The cover plate 14 has a venting hole 16 at the center. A rubber valve element 18 is disposed on the external surface of the cover plate 14 so as to close the venting hole 16. Further, a cylindrical positive terminal 20 with a flange is fixed on the external surface of the cover plate 14 so as to surround the valve element 18 and the positive terminal 20 is protruded in the direction of the longitudinal axis from the container 10 at the side of the opening end. The valve element 18 is pressed by the positive terminal 20 to the cover plate 14, and therefore, the container 10 is normally sealed in an airtight manner by the insulating-packing 12, the valve element 18 and the cover plate 14. On the other hand, when the internal pressure of the container 10 rises due to the generation of gas, the valve element 18 is compressed, allowing the gas to be released from the container 10 through the venting hole 16. Namely, the cover plate 14, the valve element 18 and the positive terminal 20 constitute a safety valve that operates when the internal pressure of the battery exceeds a predetermined pressure.

Here, the length from the distal end of the positive terminal 20 to the bottom face of the container 10, that is, the height (H) of the battery is in the inclusive range of 49.2 mm to 50.5 mm. Provided that the volume (Vb) of the battery is equal to the volume of a cylindrical body having an outer diameter (D) and a height (H), the volume (Vb) is defined by the following formula:
Vb=π(D/2)²×H

A cylindrical electrode assembly 22 is housed in the container 10, wherein the outermost periphery of the electrode assembly 22 is directly contacted with the inner surface of the container 10. The electrode assembly 22 is consisting of a positive plate 24, a negative plate 26 and a separator 28. The electrode assembly 22 is formed such that the positive plate 24 and the negative plate 26 are spirally wound with the separator 28 sandwiched therebetween. That is, the positive plate 24 and the negative plate 26 are alternately superimposed with the separator 28 sandwiched therebetween in the direction of the radius of the electrode assembly 22. A part of the negative plate 26 is wound at the outermost periphery of the electrode assembly 22 such that the negative plate 26 and the container 10 are electrically connected with each other at the outermost periphery portion of the electrode assembly 22.

Furthermore, a positive electrode lead 30 is disposed between one end of the electrode assembly 22 and the cover plate 14, and has opposite ends welded to the positive plate 24 and the cover plate 14, respectively. Therefore, the positive terminal 20 and the positive plate 24 are electrically connected with each other through the positive electrode lead 30 and the cover plate 14. More specifically, the positive electrode lead 30 is in the form of a strip, and the positive electrode lead 30 is housed in the container 10 such that it is folded between the electrode assembly 22 and the cover plate 14 when the cover plate 14 is disposed in the opening of the container 10. The end of the positive electrode lead 30 in the side of the electrode assembly 22 is welded to one surface of the positive plate 24 in the state of surface contact. It should be noted that a circular insulating member 32 is disposed between the cover plate 14 and the electrode assembly 22, while the positive electrode lead 30 extends via a slit formed through the insulating member 32. Furthermore, a circular insulating member 34 is disposed between the electrode assembly 22 and the bottom of the container 10.

The positive plate 24 is constituted by a porous substrate with electrical conductivity, and a positive mixture filled into the porous substrate. The porous substrate with electrical conductivity is made of, for example, nickel, and has a three-dimensional network structure. The reference number “36” in the FIGURE indicates the skeleton of the porous substrate, and the reference number “38” indicates a positive mixture with which the vacancies of the porous substrate are filled.

The positive mixture 38 contains a positive-electrode active material, and a binding material 40 for securing the positive electrode active material, and may further contains various additive particles for improving the characteristics of the positive plate 24.

In addition, preferably the mass of the positive electrode active material contained in the positive mixture 38 of the positive plate 24 is set such that the battery can have a volume energy density of 340 Wh/liter to 450 Wh/liter, both inclusive. The volume energy density of the battery means a value given by multiplying the 0.2 C-capacity of the battery by 1.2 V as an operating voltage and dividing the product by the volume (Vb) of the battery mentioned above. The 0.2 C-capacity of battery is defined in JIS C 8708-1997 and is obtained in the following manner. First, a battery kept at an ambient temperature of 20±5° C. is charged with an electric current equivalent to 0.1 C for 16 hours, and after being kept at rest for one to four hours, the battery is discharged with an electric current equivalent to 0.2 C to a discharge end voltage of 1.0 V, to measure the 0.2 C-capacity.

As schematically shown in the inside of the circle of the FIGURE, the positive mixture 38 comprises first particles 42 and second particles 44 as positive-electrode active materials, and may further comprise third particles 46.

The first particle 42 comprises a core material 42a of higher-order nickel hydroxide, wherein the core material 42a can be obtained by converting a part or the whole of the nickel hydroxide particles into higher-order nickel hydroxide.

Preferably, a coating 42b of a high-ordered cobalt compound such as cobalt oxyhydroxide is formed in a part or the whole of the surface of the core material 42a. Furthermore, preferably the shape of the first particle 42 is a generally spherical type having an average particle size of approximately 8 to 20 μm, wherein the first particle 42 can be obtained by subjecting the third particle 46 to a chemical oxidization treatment as described later.

The chemical oxidization treatment can be carried out by dipping the third particle 46 into a solution in which an oxidizing agent such as sodium hypochlorite, sodium thiosulfate, potassium thiosulfate, potassium peroxosulfate or sodium peroxosulfate is dissolved, for a predetermined time. In this case, preferably the dipping time, the concentration of the oxidizing agent, the temperature and the like are adjusted to provide an average valence number of nickel after the treatment of about 2.1 to 2.5, because when the average valence number is such a value, effects such as the improvement of the cycle characteristics (or the cycle life characteristics) due to the reduction of a discharge reserve, and the high densification of the positive mixture due to higher-ordered nickel hydroxide can be expected.

The second particle 44 is obtained by pulverizing a spherical particle of nickel hydroxide. The second particle 44 is wholly nonspherical, and its surface has minute irregularity. That is, the second particle 44 is a deformed particle whose specific surface is increased. The average particle size of the second particle 44 is, for example, approximately 1.0 to 4.0 μm. There is no active compound such as a higher-ordered cobalt compound, or higher-ordered nickel hydroxide (nickel oxyhydroxide) on the surface layer of the second particle 44, which is different from the case of the first particle 42 or the third particle 46.

The third particle 46 has a core material 46a of nickel hydroxide, while the average valence number of nickel in the third particles 46 is lower than that of the first particles 42. It should be noted that nickel hydroxide may include a small amount of Co and/or Zn.

Preferably, a coating 46b of a higher-order cobalt compound such as cobalt oxyhydroxide is formed in a part or the whole of the surface of the core material 46a of the third particle 46. Furthermore, preferably the third particle 46 has a generally spherical shape with an average particle size of approximately 8 to 20 μm.

The coating 46b on the third particle 46 is provided to improve the load-shelf characteristics, that is, the characteristics of the battery after long-term storing with a resistance being connected to, the over discharge characteristics and the discharge characteristics. In order to attain the purpose, a cobalt compound in the coating 46b is higher-ordered such that the average valence number of 2.8 or more can be attained for cobalt in the cobalt compound.

In order to form the coating 46b, a publicly known method may be used wherein for example, cobalt hydroxide is precipitated on the surface of a spherical particle of nickel hydroxide, and the particle of nickel hydroxide on which cobalt hydroxide is precipitated is subjected to a heat alkaline treatment in the air. The valence number of 2.8 or more can be attained for cobalt in cobalt hydroxide by adjusting the treatment conditions in this case.

When the problem of the filling density of the porous substrate with the positive mixture 38 is considered, in order to increase the filling density, it is preferred that the first particles 42, the second particles 44 and the third particles 46 exist as densely as possible. Thus, it is preferred to use particles having a tap density in the range of 2.30 to 2.45 g/cm³ as the third particles 46, because the filling density with the positive mixture 38 is increased.

At this time, provided that the content of the first particles 42 in the positive electrode active material is x % by mass, and the content of the third particles 46 is z % by mass, preferably, “x” and “z” are set such that they can simultaneously satisfy the relationship of the following formulae:
10≦100×x/(x+z)≦40, and
60≦100×z/(x+z)≦90.

That is, due to the mixing ratio of the first particles 42 and the third particles 46, the relative content of the first particles 42 can be decreased, wherein the first particles 42 is higher-ordered whereby the surfaces are activated. Thus, interactions between the binding material 40 added to the positive electrode slurry and the first particles 42 are suppressed, and thus the destabilization of the positive electrode slurry is suppressed. As a result, the filling characteristics of the porous substrate with the positive mixture 38 can be enhanced, and thus it can be realized to make the battery having a high capacity, while the merit such that the discharge reserve is controlled by the use of the first particles 42 is secured.

Now, when the value “100×z/(x+z)” is larger than 90%, in other words, when the value “100×x/(x+z)” is smaller than 10%, the abundance ratio of the first particles 42 having active surfaces becomes excessively small in the positive electrode, whereby the merit such that the discharge reserve is controlled is diminished. On the other hand, when the value “100×z/(x+z)” is smaller than 60%, in other words, when the value “100×x/(x+z)” is larger than 40%, the abundance ratio of the first particles 42 becomes excessively large and interactions between the binding material 40 and the first particles 42 becomes strong. As a result, the destabilization of the positive electrode slurry becomes remarkable, whereby the high-density filling of the porous substrate with the positive mixture 38 is inhibited.

The positive electrode slurry can be obtained by mixing and stirring the first particles 42, the second particles 44, the binding material 40 and water, and in some cases the third particles 46. Preferably, a proper amount of a surface active agent may be added to the positive electrode slurry.

The type of the surface active agent is not limited in particular. As the surface active agent, for example, a nonionic surface active agent such as an alkyl ether type, or an alkylphenol type can be used. Specifically, polyoxyethylene alkyl ether, phenol ethoxylate, or the like can be used.

The surface active agent acts upon the surface of higher-ordered nickel hydroxide of the first particle 42, whereby the surface tension of higher-ordered nickel hydroxide is suppressed. Furthermore, the surface active agent suppresses a binding reaction of the binding material 40 and higher-ordered nickel hydroxide, whereby the binding material 40 is homogeneously dispersed into the positive electrode slurry. As a result, the positive electrode slurry is wholly stabilized by the surface active agent.

However, when the surface active agent is merely added to the positive electrode slurry, the action of the surface active agent to the surface of higher-ordered nickel hydroxide is strong, and thus the surface tension of higher-ordered nickel hydroxide selectively becomes small, whereby the viscosity of the positive electrode slurry is drastically decreased, so that the positive electrode slurry is destabilized.

However, there is the second particles 44, each of which has a large specific surface area, in the positive electrode slurry as mentioned above. As a result, the positive electrode slurry is retained in the state of stability, whereby the high-density filling of the porous substrate with the positive mixture 38 can be attained.

Provided that the content of the second particles 44 in the positive active material is y % by mass, preferably “y” is a value satisfying the relationship of the following formula:
4≦100×y/(x+y+z)≦12.

When the content of the second particles 44 in the positive electrode active material is smaller than 4% by mass or the value “100×y/(x+y+z)” is smaller than 4%, the effect mentioned above can not be satisfactorily attained. Thus, the positive electrode slurry is destabilized, and the filling density of the porous substrate with the positive mixture 38 tends to be decreased. On the other hand, when the content of the second particle 44 is larger than 12% by mass or the value “100×y/(x+y+z)” is larger than 12%, it becomes difficult to smoothly fill the porous substrate with the positive electrode slurry, because the second particles 44 are deformed particles. Furthermore, in this case, the relative amount of the first particles 42 to the third particles 46 in the positive mixture 38 is decreased, whereby the capacity of the resultant battery is decreased.

In addition, preferably the amount of the surface active agent formulated is approximately in the range of 0.01 to 0.10% by mass based on the amount of the positive mixture 38, depending upon the usage of the positive active material and the usage of the binding material 40. When the amount of the surface active agent is smaller than 0.01% by mass, the effect mentioned above, i.e. the homogeneous dispersion of the binding material 40 is not exerted. On the other hand, when the amount of the surface active agent is larger than 0.10% by mass, the characteristics of the resultant battery are adversely affected. More preferably, the amount of the surface active agent formulated is in the range of 0.01 to 0.03% by mass.

The vacancies of the porous substrate are filled with the positive electrode slurry as prepared, and then the filled porous substrate is subjected to drying and rolling treatments, whereby the positive electrode slurry is formed into the positive mixture 38. Thereafter, the porous substrate as subjected to drying and rolling treatments is cut out into a predetermined size, whereby the positive plate 24 is obtained.

The first particles 42 and the second particles 44, and in some cases, the third particles 46 are used in the positive electrode slurry for the positive plate 24, whereby the filling density of the positive mixture 38 can be increased to a high value in the range of 3.20 to 3.40 g/m³. When the whole volume of vacancies in the porous substrate is S (cm³), and the filled amount of the positive mixture 38 is M (g), the filling density of the positive mixture 38 is shown as M/S. Preferably the filling density is in the range of 3.25 to 3.40 g/m³.

Then, the positive plate 24 is incorporated, whereby a high production efficiency nickel-hydrogen secondary battery having a ratio of the liquid measure of the alkaline electrolyte to the battery capacity of 0.85 ml/Ah or less can be manufactured. When the liquid measure of the alkaline electrolyte injected into the container 10 is Ve (ml), and the 0.2 C-capacity of the battery is Q (Ah), the ratio of the liquid measure of the electrolyte to the capacity is represented by Ve/Q.

Furthermore, a good shape-characteristics battery having a volume energy density of 340 to 450 Wh/liter can be manufactured by incorporating the positive plate 24.

Besides, the positive plate 24 is, at a high density, filled with the positive mixture 38 including higher-ordered nickel hydroxide, and thus the battery as described above has a high capacity and is excellent in cycle life characteristics, while ensuring a merit arising from controlling discharge reserve.

### EXAMPLES

1. Production of Positive Plate

Spherical nickel-hydroxide particles having an average particle size of 10 μm, the surfaces of which are coated with cobalt hydroxide, were subjected to heat alkaline treatment in the air, whereby third particles were produced wherein cobalt is higher ordered to have an average valence number of 3.2.

A part of third particles was batched off, and the thus batched-off third particles were placed in an aqueous sodium hypochlorite solution, followed by stirring at a temperature of 60° C. for a predetermined time. Thus, a part of nickel hydroxide was oxidized, and first particles comprising nickel hydroxide wherein nickel is higher ordered to have an average valence number of 2.3 was produced.

Furthermore, spherical nickel-hydroxide particles, the surfaces of which were not coated with cobalt hydroxide, were separately produced, and these particles were mechanically pulverized to produce nonspherical second particles having an average particle size of about 2 μm.

These particles were mixed at a ratio as shown in Table 1 such that the total ratio became 100 parts by mass, and 0.18 part by mass of carboxymethyl cellulose (as a binding material) was added thereto and mixed. Furthermore, polyoxyethylene alkyl ether (as a surface active agent) was added thereto at a ratio as shown in Table 1, and thereafter 30 parts by mass of water was added thereto and mixed to prepare a positive electrode slurry.

A porous substrate made of nickel was filled with the prepared positive electrode slurry. Thereafter, the filled porous substrate was sequentially subjected to drying treatment and rolling, and the resultant substrate was cut off into a predetermined size to produce a positive plate of Example 1.

2. Production of Negative Plate

A hydrogen storing alloy powder having a publicly known composition was used. To 100 parts by mass of this powder, 0.3 parts by mass of a binding material comprising a hydrophilic resin was added, followed by mixing. Furthermore, to the mixture, 30 parts by mass of water was added to, followed by kneading to prepare a slurry. This slurry was applied to a core body comprising a punched metal, followed by drying and rolling to produce a negative plate.

3. Fabrication of Alkaline Secondary Battery

The positive plate and negative plate produced as described above were spirally wound with a separator sandwiched therebetween to make an electrode assembly, and the electrode assembly was housed in an exterior can having a bottom, and an alkaline electrolyte was injected into the exterior can, followed by sealing to fabricate an AA-sized nickel-hydrogen secondary battery with a capacity of 2700 mAh. This nickel-hydrogen secondary battery was subjected to activation treatment under predetermined conditions to obtain an alkaline secondary battery of Example 1.

Furthermore, positive plates of Examples 2 to 8 and Comparative Examples 1 to 4 was produced, respectively, in a similar manner to Example 1, except that the amount of the surface active agent added, the content of each of first, second and third particles used, and the average valence number of nickel in the first particles used as shown in Table 1, when the positive electrode slurry was prepared. Thereafter, in each case, a nickel-hydrogen secondary battery into which the elements above were incorporated was fabricated, followed by activation treatment under the same condition in Example 1

4. Evaluation of Positive Plate and Alkaline Secondary Battery

(1) Filling Density of Positive mixture

With respect to the positive plates of Examples 1 to 8 and Comparative Examples 1 to 4, the filling density of the positive mixture was determined. The results are shown in Table 1.

When the whole volume of vacancies in a porous substrate is S (cm³), and the filling amount of a positive mixture is M (g), the filling density can be indicated by M/S. The filling amount of the positive mixture is a value obtained by subtracting the mass of the porous substrate from the mass of the whole positive plate. The whole volume of vacancies in the porous substrate is a value obtained by dividing the mass of the substrate divided by the specific gravity of the substrate material and subtracting the quotient from the whole volume of the positive plate.

(2) The fabrication yield of the nickel-hydrogen secondary battery of each of Examples 1 to 8 and Comparative Examples 1 to 4 was determined. The results are shown in Table 1.

The fabrication yield was defined as the percentage of “the number of the batteries obtained finally as non-defective batteries after the activation had been finished” relative to “the number of the positive plates used when the batteries were fabricated”, that is, “(the number of the finally non-defective batteries)/(the number of the cut-off positive plates)”×100 (%).

Cycle Life Characteristics of Batteries

The cycle life characteristics of each of the batteries subjected to the initial activation treatment was evaluated. The results are shown in Table 1.

The discharge capacity was determined each cycle for the cycle life characteristics. The number of cycles when the discharge capacity was decreased to 80% or less of the discharge capacity at the first cycle was counted as the cycle life.

Each cycle comprises the steps of: charging: 1 C (which is finished when −ΔV=10 mV); making a pause: for 30 minutes; discharging: 1 C (with final voltage of 1 V); and making a pause: for 30 minutes.

TABLE 1

| | Amount of | | | | | | | | | | |
|---|---|---|---|---|---|---|---|---|---|---|---|
| | Surface | | | | | | | | | | |
| | Active Agent | | | | | | | | | | |
| | Added when | State of Content of each Particle in Active Material | | | | | | | | | |
| | preparation | First Particle | | | | | | | Filling | | |
| | of slurry | | | Average | Second Particle | | Third Particle | | Density | Fabri- | |
| | (% by mass | Content | | Valence | Content | | Content | | of Positive | cation | Cycle |
| | in positive | (x: % by | 100 × x/ | Number | (y: % by | 100 × y/ | (z: % by | 100 × z/ | mixture | Yield | Life |
| | mixture) | mass) | (x + z) | of Nickel | mass) | (x + y + z) | mass) | (x + z) | (g/cm³) | (%) | (time) |
| Example 1 | — | 90.9 | 100 | 2.1 | 9.1 | 9.1 | — | 0 | 3.21 | 96.5 | 210 |
| Example 2 | — | 18.2 | 20 | 2.3 | 9.1 | 9.1 | 72.7 | 80 | 3.24 | 97.0 | 210 |
| Example 3 | — | 36.4 | 40 | 2.2 | 9.1 | 9.1 | 54.5 | 60 | 3.23 | 96.6 | 210 |
| Example 4 | — | 9.1 | 10 | 2.5 | 9.1 | 9.1 | 81.8 | 90 | 3.24 | 97.0 | 210 |
| Example 5 | — | 19.0 | 20 | 2.3 | 4.8 | 4.8 | 76.2 | 80 | 3.20 | 95.8 | 210 |
| Example 6 | — | 17.7 | 20 | 2.3 | 11.5 | 11.5 | 70.8 | 80 | 3.20 | 95.5 | 210 |
| Example 7 | 0.02 | 90.9 | 100 | 2.1 | 9.1 | 9.1 | — | 0 | 3.33 | 98.0 | 200 |
| Example 8 | 0.02 | 18.2 | 20 | 2.3 | 9.1 | 9.1 | 72.7 | 80 | 3.34 | 98.0 | 200 |
| Comp. Ex. 1 | 0.02 | 90.9 | 100 | 2.1 | — | 0 | — | 0 | 3.18 | 88.0 | 130 |
| Comp. Ex. 2 | — | 90.9 | 100 | 2.1 | — | 0 | — | 0 | 3.12 | 85.0 | 140 |
| Comp. Ex. 3 | 0.02 | 20 | 20 | 2.3 | — | 0 | 80 | 80 | 3.18 | 89.0 | 130 |
| Comp. Ex. 4 | — | 20 | 20 | 2.3 | — | 0 | 80 | 80 | 3.15 | 88.0 | 140 |

The following are apparent from Table 1.

(1) The fabrication yield of each of Examples 1 to 8 is better than that of each of Comparative Examples 1 to 4;

(2) In the case of the positive plates of Examples 1 to 8, the filling density of each of the positive plates with the positive mixture can be increased to 3.20 g/cm³ or more. The battery into which a positive plate of any one of Examples 1 to 8 is incorporated is excellent in cycle characteristics.

(3) In the case of the positive plates of Examples 7 and 8 wherein the positive plates were produced by using the positive electrode slurry to which the surface active agent was added, the filling density of each of the positive plates with the positive mixture is further increased to 3.24 g/cm³ or more. Thus, in the case of the batteries of Examples 7 and 8 wherein any one of the positive plates is incorporated, a higher constriction-degree within each of the batteries can be set, while the productivity and characteristics of the batteries are well balanced.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A positive plate for alkaline secondary battery, comprising:
a porous substrate having electrical conductivity and vacancies; and
a positive mixture filled into the vacancies of the porous substrate, the positive mixture including a positive electrode active material and a binding agent, the positive electrode active material having generally spherical first particles containing higher-ordered nickel hydroxide, and nonspherical second particles containing nickel hydroxide and having an average valence number of nickel lower than an average valence number of nickel in the first particles.

2. The positive plate according to claim 1, wherein, provided that a content of the first particles in the active material is x % by mass and that a content of the second particles in the active material is y % by mass, “x” and “y” satisfy a relationship of a following formula:
4≦100×y/(x+y)≦12.

3. The positive plate according to claim 1, wherein the positive electrode active material further includes generally spherical third particles containing nickel hydroxide and having an average valence number of nickel lower than the average valence number of nickel in the first particle.

4. The positive plate according to claim 3, wherein, provided that a content of the first particles in the active material is x % by mass and that a content of the third particles is z % by mass, “x” and “z” satisfy relationships of following formulae:
10≦100×x/(x+z)≦40, and 60≦100×z/(x+z)≦90.

5. The positive plate according to claim 4, wherein, provided that a content of the second particles in the active material is y % by mass, “x”, “y” and “z” satisfy a relationship of a following formula:
4≦100×y/(x+y+z)≦12.

6. The positive plate according to claim 2, wherein the positive mixture further includes a surface active agent.

7. The positive plate according to claim 5, wherein the positive mixture further comprises a surface active agent.

8. The positive plate according to claim 2, wherein, provided that a whole volume of the vacancies in the porous substrate is S (cm³) and that a filling amount of the positive mixture is M (g), a filling density of the positive mixture indicated by M/S is in a range of 3.20 to 3.40 g/cm³.

9. The positive plate according to claim 5, wherein, provided that a whole volume of the vacancies in the porous substrate is S (cm³) and that a filling amount of the positive mixture is M (g), a filling density of the positive mixture indicated by M/S is in a range of 3.20 to 3.40 g/cm³.

10. An alkaline secondary battery, comprising:
a container;
an alkaline electrolyte housed in the container; and
an electrode assembly housed in the container, the electrode assembly including a positive plate, a negative plate and a separator, the positive plate and the negative plate overlapping each other with the separator sandwiched therebetween, the positive plate including a porous substrate having an electrical conductivity and vacancies, and a positive mixture filled into the vacancies of the porous substrate, the positive mixture containing an active material and a binding agent, the active material having generally spherical first particles containing higher-ordered nickel hydroxide, and nonspherical second particles containing nickel hydroxide and having an average valence number of nickel lower than an average valence number of nickel in the first particles.

11. The alkaline secondary battery according to claim 10, wherein, provided that a liquid measure of the alkaline electrolyte is Ve (ml) and that a 0.2 C-capacity of the battery is Q (Ah), a ratio of the liquid measure to the 0.2 C-capacity indicated by Ve/Q is 0.85 ml/Ah or less.

12. The alkaline secondary battery according to claim 10, wherein a volume energy density is 340 to 450 Wh/L.

13. The alkaline secondary battery according to claim 10, wherein, provided that a content of the first particles in the active material is x % by mass and that a content of the second particles in the active material is y % by mass, “x” and “y” satisfy a relationship of a following formula:
4≦100×y/(x+y)≦12.

14. The alkaline secondary battery according to claim 10, wherein the positive electrode active material further has generally spherical third particles containing nickel hydroxide and having an average valence number of nickel lower than the average valence number of nickel in the first particle.

15. The alkaline secondary battery according to claim 14, wherein, provided that a content of the first particles in the active material is x % by mass and that a content of the third particles is z % by mass, “x” and “z” satisfy relationships of following formulae:
10≦100×x/(x+z)≦40, and 60≦100×z/(x+z)≦90.

16. The alkaline secondary battery according to claim 15, provided that a content of the second particles in the active material is y % by mass, “x”, “y” and “z” satisfy a relationship of a following formula:
4≦100×y/(x+y+z)≦12.

17. The alkaline secondary battery according to claim 13, wherein the positive mixture further contains a surface active agent.

18. The alkaline secondary battery according to claim 16, wherein the positive mixture further contains a surface active agent.

19. The alkaline secondary battery according to claim 13, wherein, provided that a whole volume of the vacancies in the porous substrate is S (cm³) and that a filling amount of the positive mixture is M (g), a filling density of the positive mixture indicated by M/S is in a range of 3.20 to 3.40 g/cm³ and
wherein a volume energy density is 340 to 450 Wh/L.

20. The alkaline secondary battery according to claim 16, wherein, provided that a whole volume of the vacancies in the porous substrate is S (cm³) and that a filling amount of the positive mixture is M (g), a filling density of the positive mixture indicated by M/S is in a range of 3.20 to 3.40 g/cm³ and
wherein a volume energy density is 340 to 450 Wh/L.
